(19) United States
(12) Patent Application Publication
(10) Pub. No.: US 2017/0123994 A1
(43) Pub. Date: May 4, 2017

(54) Handling Of Plane Failure In Non-Volatile Storage

(71) Applicant: SanDisk Technologies Inc., Plano, TX (US)

(72) Inventors: Tosha Pandya, San Jose, CA (US); Mrinal Kochar, San Jose, CA (US); Aaron Lee, Mountain View, CA (US); Tien-Chien Kuo, Sunnyvale, CA (US)

(73) Assignee: SANDISK TECHNOLOGIES INC., Plano, TX (US)

(21) Appl. No.: 14/925,163

(22) Filed: Oct. 28, 2015

(51) Int. Cl. G06F 12/10

(52) U.S. Cl. CPC G06F 12/10; G06F 2212/202; G06F 2212/65

(57) ABSTRACT

Technology is described herein for reclaiming a memory device that has a defective plane. A solution allows a memory device with a defective plane to operate as a single plane device. The memory device with the defective plane may be used without any changes to the memory controller. Thus, the memory controller can send single plane commands to the memory device with the defective plane by using single plane addressing. The memory device may have logic that properly translates the single plane command so that it is compliant with the memory mapping of the multi-plane memory device with the defective plane. Thus, the command will access the correct block in the correct plane.

### BACKGROUND

The present disclosure relates to technology for non-volatile storage.

Semiconductor memory is used in various electronic devices. For example, non-volatile semiconductor memory is used in cellular telephones, digital cameras, personal digital assistants, mobile computing devices, non-mobile computing devices and other devices. Electrical Erasable Programmable Read Only Memory (EEPROM) and flash memory are among the most popular non-volatile semiconductor memories.

Typically, the memory device has a memory controller and one or more memory packages. The memory package has one or more logical units. As one example, each logical unit can be a separate memory die. Each memory die contains non-volatile storage elements (e.g., memory cells), as well as read and write circuitry. The memory package also contains addressing circuitry in order to properly address the memory cells. As one example, the memory package includes NAND flash memory. However, memory packages other than NAND flash are known.

The memory controller controls operation of the various memory packages. For example, the memory controller sends read, write (or program), erase, and other commands to the memory package. For some memory devices, the memory cells are organized as blocks. The commands identify which block of memory cells are to be accessed, in one possible scheme. Note that for some commands the address in the command further specifies which memory cells within the block are to be accessed.

To achieve better parallelism, each logical unit in the memory package can be divided into multiple planes. A plane may be defined as a unit that is able to report its own operating status and can perform command execution independent of other planes in the logical unit. For example, each plane may have its own data registers, data buffers, etc., to enable independent command operation. As one example, a memory controller can send a multi-plane read command to the logical unit, which executes read commands in two (or more) planes in parallel. Other example multi-plane commands include, but are not limited to, multi-plane program and multi-plane erase.

### BRIEF DESCRIPTION OF THE DRAWINGS

FIG. 1A is a perspective view of a 3D stacked non-volatile memory device in which embodiments may be practiced.

FIG. 1B is a functional block diagram of a memory device such as the 3D stacked non-volatile memory device of FIG. 1A.

FIG. 1C show N memory packages, and N channels for communication between Controller and the memory die of respective packages.

FIG. 2A is a diagram of one example of blocks in a memory die having a single plane.

FIG. 2B is a diagram of one embodiment of blocks in a multi-plane memory die.

FIG. 2C depicts a diagram of another example of blocks in a memory die having a single plane

FIG. 2D depicts a diagram of another embodiment of blocks in a multi-plane memory die.

FIG. 3A is an example memory mapping scheme for a single-plane memory configuration.

FIG. 3B is an example memory mapping scheme for a multi-plane memory configuration.

FIGS. 4A and 4B are block diagrams of one embodiment of address translation circuity and associated elements.

FIGS. 4C and 4D is are block diagrams of one embodiment chip address logic that performs an address translation for a chip address.

FIG. 5A is a flowchart of one embodiment of a process of informing a memory controller that there is a plane that is disabled.

FIG. 5B is a flowchart of one embodiment of a process of accessing memory cells in a device in which a plane is disabled.

FIG. 6 is a flowchart of one embodiment of a process of operating a memory device.

FIG. 7 depicts an example of cycles of a command.

FIGS. 8A and 8B show mapping examples in accordance with one embodiment.

### DETAILED DESCRIPTION

Technology is described herein for reclaiming a memory device that has a defective plane. In some cases, tests performed on the memory device may reveal that one of the planes is defective. When one plane is defective, this means that some blocks on the die are not accessible. This may result in a multi-plane memory device only being usable as a single-plane memory device. However, operating the memory device as a single-plane memory device may present addressing challenges. Typically, the address mapping depends on the configuration of the memory device. Each block on a given die may have a unique block number, in one possible addressing scheme. The address mapping may define which block numbers are in which plane. For example, a memory device that was manufactured with two planes and 64 GB of memory per die will typically have a different address mapping than a memory device that was manufactured with one plane and 32 GB of memory per die. An implication of the foregoing is that the memory device with the defective plane may have an internal memory mapping that uses a two plane configuration.

The memory controller may be configured to properly address a memory device with multi-planes and the multi-plane address mapping. Likewise, the memory controller may be configured to properly address a memory device with a single plane and the single-plane address mapping. However, the memory controller may not be configured to properly address a memory device with a single functional plane but a multi-plane address mapping. For example, the memory controller might send a command that has a block address in the defective plane. Thus, the memory controller may not be configured to properly address the example memory device with the defective plane. Changes might be made to the memory controller to enable it to properly address a memory device with a single functional plane and a multi-plane address mapping. However, such changes could be costly, could require significant testing, etc.

Embodiments disclosed herein provide a solution that allows a memory device with a defective plane to operate as a device with fewer planes. In one embodiment, a memory device with a defective plane operates as a single plane device. The memory device with the defective plane may be used without any changes to the memory controller. Thus, the memory controller can send single plane commands to the memory device with the defective plane. In one embodiment, the memory package has logic that properly translates the single plane command so that it is compliant with the memory mapping of the multi-plane memory package with the defective plane. Thus, the command will access the correct block in the correct plane.

In one embodiment, a memory device with one defective plane out of four planes per die operates as a two plane device. In one embodiment, the memory controller can send two-plane commands to a four-plane memory device with a defective plane. In one embodiment, the memory package has logic that properly translates the two-plane command so that it is compliant with the memory mapping of the four-plane memory package with the defective plane. Thus, the command will access the correct block in the correct plane. This solution can be extended to devices with more than four planes per memory die.

The memory device is a NAND memory device, in one embodiment. Embodiments are applicable to 2D NAND and 3D NAND, but not necessarily limited thereto.

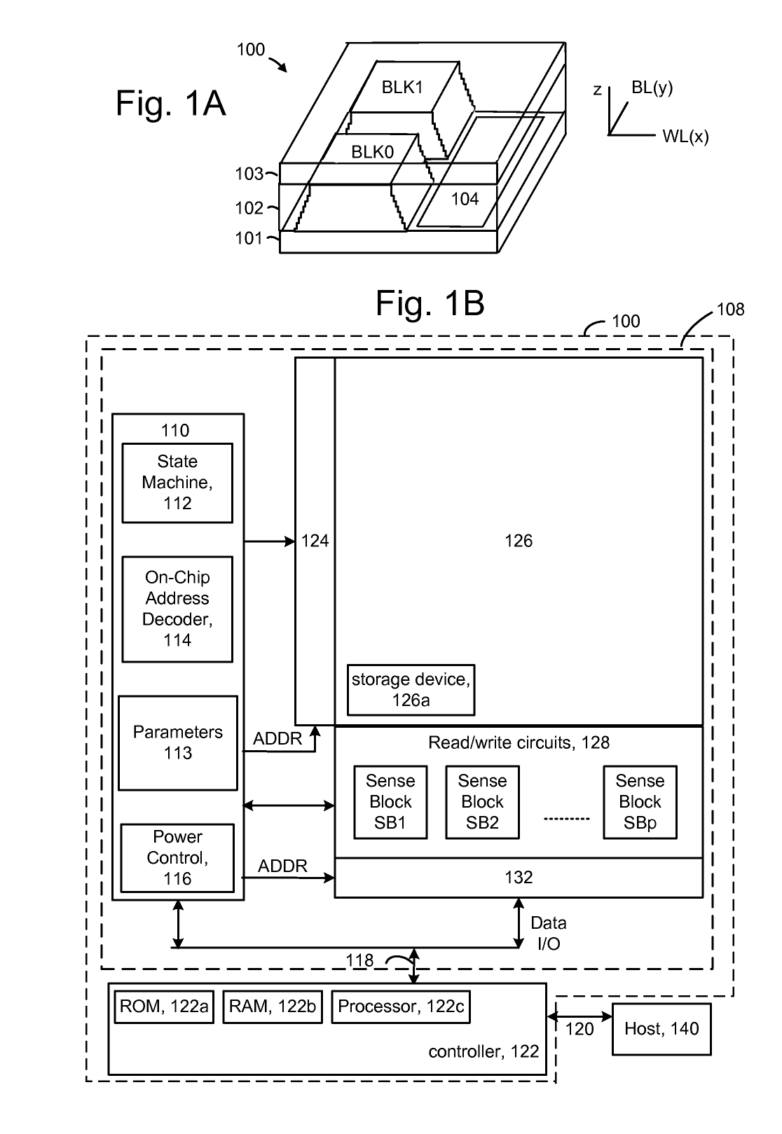

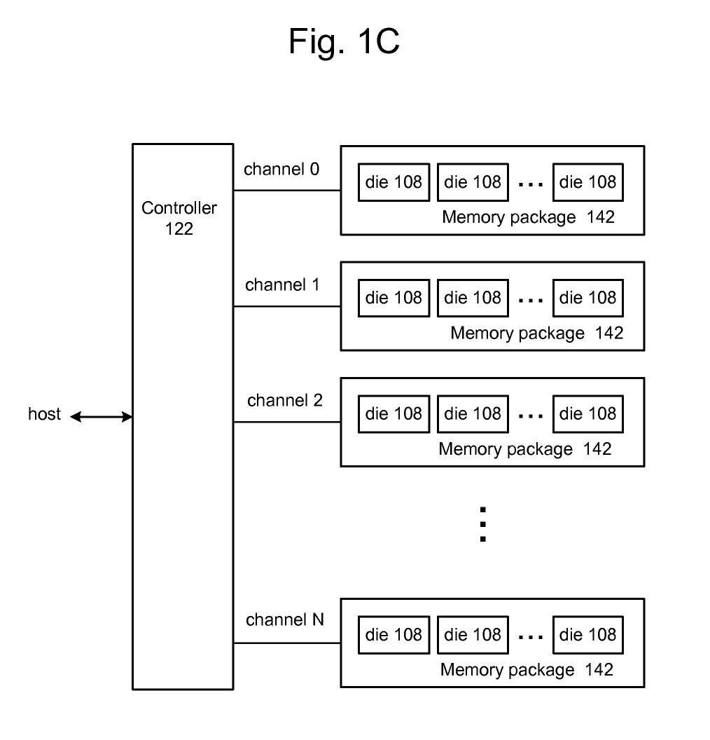

FIG. 1A is a perspective view of a 3D stacked non-volatile memory device in which embodiments may be practiced. The memory device 100 includes a substrate 101. On and above the substrate are example blocks BLK0 and BLK1 of memory cells (non-volatile storage elements). Also on the substrate is a peripheral area 104 with circuitry for use by the blocks. The substrate 101 can also carry circuitry under the blocks, along with one or more lower metal layers which are patterned in conductive paths to carry signals of the circuitry. The blocks are formed in an intermediate region 102 of the memory device. In an upper region 103 of the memory device, one or more upper metal layers are patterned in conductive paths to carry signals of the circuitry. Each block comprises a stacked area of memory cells, where alternating levels of the stack represent word lines. In one possible approach, each block has opposing tiered sides from which vertical contacts extend upward to an upper metal layer to form connections to conductive paths. While two blocks are depicted as an example, additional blocks can be used, extending in the x- and/or y-directions. The z-direction represents a height of the memory device. Additionally, note that components are considered to be connected if they are directly connected or indirectly connected.

FIG. 1B is a functional block diagram of a memory device such as the 3D stacked non-volatile memory device 100 of FIG. 1A. The memory device 100 may include one or more memory die 108. The memory die 108 includes a memory structure 126 of memory cells, such as an array of memory cells, control circuitry 110, and read/write circuits 128. The memory die 108 may include multiple planes, which will be discussed below. The memory structure 126 is addressable by word lines via a row decoder 124 and by bit lines via a column decoder 132. In a 3D configuration, the memory structure can include the blocks BLK0 and BLK1 of FIG. 1A. The read/write circuits 128 include multiple sense blocks SB1, SB2, . . . , SBp (sensing circuitry) and allow a page of memory cells to be read or programmed in parallel. Typically a controller 122 is included in the same memory device 100 (e.g., a removable storage card) as the one or more memory die 108. In some embodiments, one controller will communicate with multiple memory die. Commands and data are transferred between the host 140 and controller 122 via a data bus 120 and between the controller and the one or more memory die 108 via lines 118. In one embodiment, the die 108 is part of a package that has pins or pads, which form part of the physical interface to the die. Certain pins (or alternatively pads) may be designated as I/O pins. In one embodiment, there are eight I/O pins (or pads). In one embodiment, there are sixteen I/O pins (or pads). However, a different number of pins may be designated as I/O pins.

Memory structure 126 can be a two dimensional structure or a three dimensional structure of memory cells (e.g., NAND flash memory cells). The memory structure may comprise one or more array of memory cells including a 3D array. The memory structure may comprise a monolithic three dimensional memory structure in which multiple memory levels are formed above (and not in) a single substrate, such as a wafer, with no intervening substrates. The memory structure may comprise any type of non-volatile memory that is monolithically formed in one or more physical levels of arrays of memory cells having an active area disposed above a silicon substrate. The memory structure may be in a non-volatile memory device having circuitry associated with the operation of the memory cells, whether the associated circuitry is above or within the substrate.

The control circuitry 110 cooperates with the read/write circuits 128 to perform memory operations on the memory structure 126, and includes a state machine 112, an on-chip address decoder 114, and a power control module 116. The state machine 112 provides chip-level control of memory operations. Parameter storage 113 may be provided for storing operational parameters. In one embodiment, the parameters 113 includes those for operating a multi-plane memory device that has a defective plane in a single-plane mode.

The on-chip address decoder 114 provides an address interface between that used by the host or a memory controller to the hardware address used by the decoders 124 and 132. In one embodiment, the on-chip address decoder 114 translates the address in a command from the memory controller 122 such that it is compatible for the memory mapping of the memory array 126.

The power control module 116 controls the power and voltages supplied to the word lines and bit lines during memory operations. It can include drivers for word line layers (WLLs) in a 3D configuration, SGS and SGD transistors and source lines. The sense blocks can include bit line drivers, in one approach. An SGS transistor is a select gate transistor at a source end of a NAND string, and an SGD transistor is a select gate transistor at a drain end of a NAND string.

In various embodiments, one or more of control circuitry 110, state machine 112, decoders 114/124/132, power control module 116, sense blocks SB1, SB2, . . . , SBp, read/write circuits 128, and controller 122 can be thought of as at least one or more control circuits which are configured to perform the functions described herein.

The off-chip controller 122 may comprise a processor 122c and storage devices (memory) such as ROM 122a and RAM 122b. The storage devices comprises code such as a set of instructions, and the processor 122c is operable to execute the set of instructions to send read, write, erase, and other commands to the memory die 108. Alternatively or additionally, processor 122c can access code from a storage device 126a of the memory structure, such as a reserved area of memory cells in one or more word lines.

When the memory structure 126 is a NAND flash memory, the various components on the die 108 may be referred to as a NAND device. Thus, in this example, the memory controller 122 sends commands to the NAND device over lines 118.

Other types of non-volatile memory in addition to NAND flash memory can also be used.

Semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse or phase change material, and optionally a steering element, such as a diode or transistor. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND flash memory) typically contain memory elements connected in series. A NAND string is an example of a set of series-connected transistors comprising memory cells and select gate transistors.

A NAND flash memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are exemplary, and memory elements may be otherwise configured.

The semiconductor memory elements located within and/or over a substrate may be arranged in two or three dimensions, such as a two dimensional memory structure or a three dimensional memory structure.

In a two dimensional memory structure, the semiconductor memory elements are arranged in a single plane or a single memory device level. Typically, in a two dimensional memory structure, memory elements are arranged in a plane (e.g., in an x-y direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and word lines.

A three dimensional memory array is arranged so that memory elements occupy multiple planes or multiple memory device levels, thereby forming a structure in three dimensions (i.e., in the x, y and z directions, where the z direction is substantially perpendicular and the x and y directions are substantially parallel to the major surface of the substrate).

As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements. The columns may be arranged in a two dimensional configuration, e.g., in an x-y plane, resulting in a three dimensional arrangement of memory elements with elements on multiple vertically stacked memory planes. Other configurations of memory elements in three dimensions can also constitute a three dimensional memory array.

By way of non-limiting example, in a three dimensional NAND memory array, the memory elements may be coupled together to form a NAND string within a single horizontal (e.g., x-y) memory device level. Alternatively, the memory elements may be coupled together to form a vertical NAND string that traverses across multiple horizontal memory device levels. Thus, in one embodiment, the non-volatile storage elements are arranged as a vertically oriented NAND strings. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Then again, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this technology is not limited to the two dimensional and three dimensional exemplary structures described but covers all relevant memory structures within the spirit and scope of the technology as described herein and as understood by one of skill in the art.

Some embodiments of a non-volatile storage system will include one memory die 108 connected to one Controller 122. The memory die 108 may have multiple planes. However, other embodiments may include multiple memory die 108 in communication with one or more Controllers. Each of the memory die 108 may have multiple planes. In one example, depicted in FIG. 1C, the multiple memory die can be grouped into a set of one or more packages. Each memory package 142 includes one or more memory die 108 in communication with Controller 122. FIG. 1C show N memory packages 142, and N channels for communication between Controller 122 and the memory die 108 of respective packages. Controller 122 communicates with the host. In other embodiments, Controller 122 can communicate with any entity via a wired or wireless network (or other type of) connection.

Each memory package 142 may have a set of pins (or alternatively pads) that are configured for input and/or output. The pins (or pads) form part of the interface (FIG. 1, 118) between the controller 122 and the memory package 142. Some of the pins (or pads) may be designated as I/O pins. This may allow for commands, addresses, and data to be received from the memory controller 122, as well as for data and other information to be returned to the memory controller 122. These pins (or pads) are compliant with a version of the Open NAND Flash interface (ONFI) specification, in one embodiment. However, the pins (or pads) are not required to be compliant with any version of the ONFI specification (even if the memory package is a NAND device). Also note that the memory package 142 is not required to be a NAND device.

Controller 122 receives a request from the host to program host data (data received from the host) into the memory system. In some embodiments, Controller 122 will arrange the host data to be programmed into units of data. For example, Controller 122 can arrange the host data into pages, word line units, blocks, super blocks, or other units. Super blocks are units of data that are programmed and read together, but span across multiple memory die 108. However, other arrangements can also be used.

In one embodiment, when one of the planes in a die is defective, the memory package 142 operates as a single plane device. In one embodiment of the example in FIG. 1C, if one of the die 108 in a memory package 142 has a defective plane, then all of the die in that memory package 142 are operated using only a single plane. In effect, that memory package 142 is operated as a single plane memory device.

In some cases, a memory die 108 could have more than two planes. For example, a memory die 108 could have four planes. In that case, if one of the four planes is defective, the memory die 108 could be operated as a one plane device or as a two plane device, in accordance with embodiments. In general, a memory die 108 with a defective plane may be operated such that the operational die are some power of two, in accordance with embodiments.

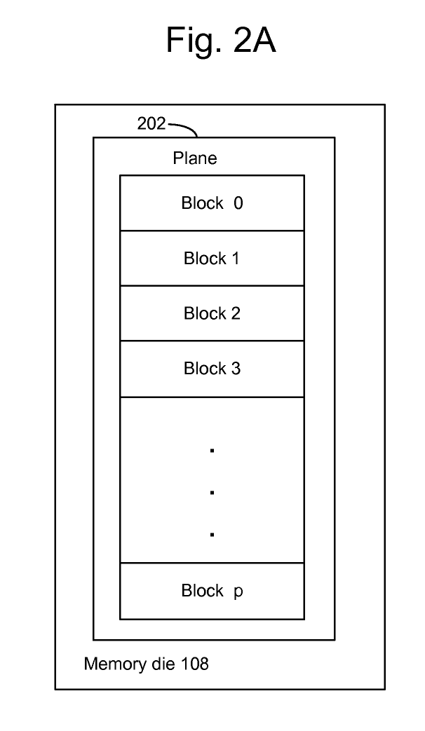

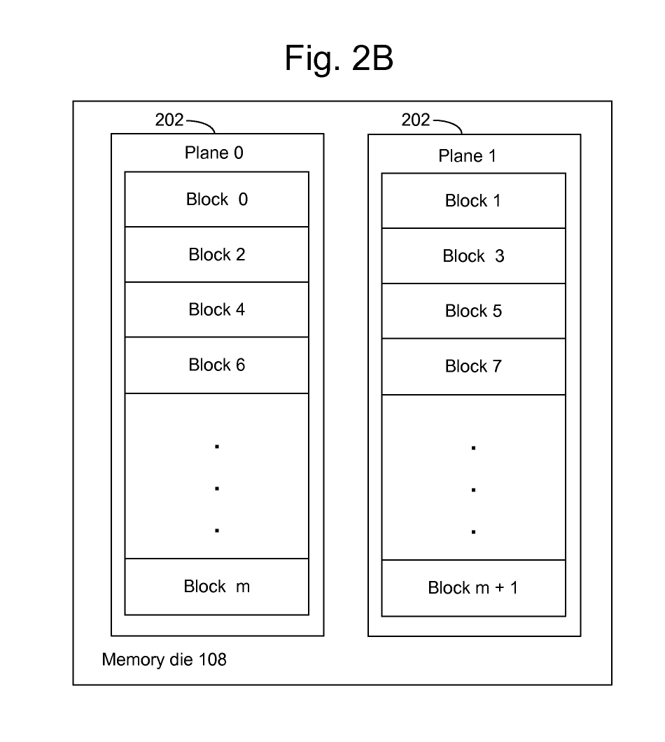

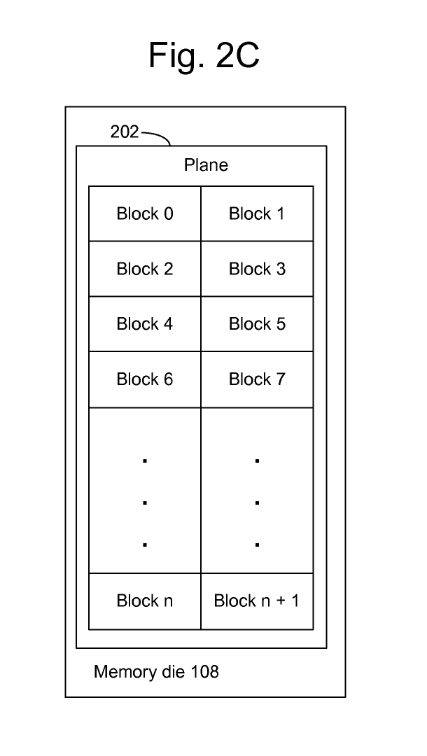

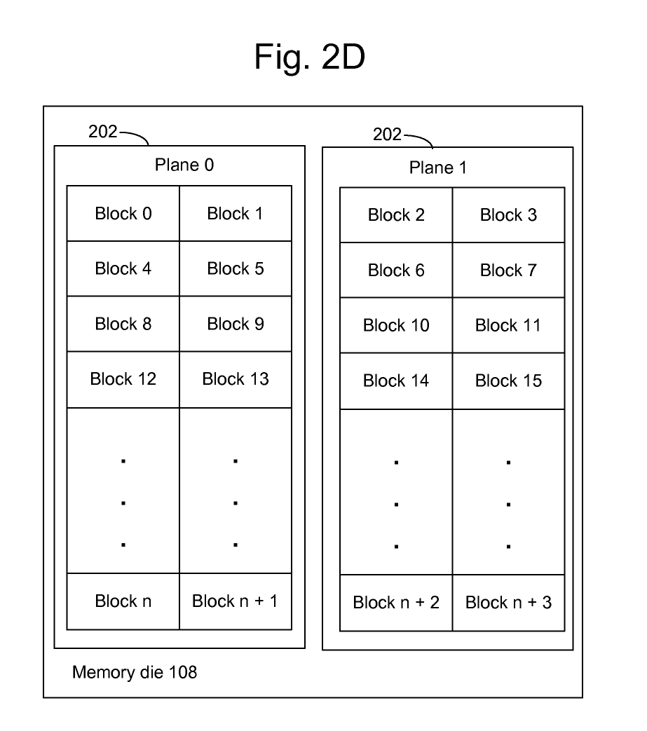

FIG. 2A is a diagram of one example of blocks in a memory die 108 having a single plane. The plane 202 has a number of physical blocks (block 0, block 1, block 2, block 3, . . . block n). Thus, there are p+1 blocks in this example. Each block contains memory cells. The single plane memory die 108 could be used for, but is not limited to, any of the die 108 in FIG. 1C. In this example, the memory controller 122 may be configured to send single plane commands to the memory die 108. The single plane command may have an address that specifies which block to access (e.g., read, write, erase). For at least some commands (e.g., read, write), the command may specify a subset of memory cells in the block to access. For some commands (e.g., erase), the command could instruct that all memory cells be accessed.

FIG. 2B is a diagram of one embodiment of blocks in a multi-plane memory die 108. The multi-plane memory die 108 has two planes 202 (Plane 0, Plane 1) in this example. In other embodiments, there could be more than two planes (e.g., four planes, eight planes, etc.). Each plane 202 has a number of physical blocks. In this example, Plane 0 has even blocks (Block 0, Block 2, . . . Block m), and Plane 1 has odd blocks (Block 1, Block 1, . . . Block m+1). Thus, the block addresses are interleaved between the two planes. The single plane memory die 108 could be used for, but is not limited to, any of the die 108 in FIG. 1C.

Each plane 202 is able to perform command execution independent of the other plane 202. For example, each plane 202 may contain its own data registers (e.g., page register, cache register, data register, etc.) and other circuitry to allow such parallel execution. The data registers and other circuitry are not depicted in FIG. 2A.

The even/odd block addressing scheme allows for efficient read and write operations. For example, the memory controller can send a multi-plane write command to write Block 0 and Block 1 in parallel. Thus, two blocks that are sequentially addressed may be written in parallel. For example, while Plane 0 is writing Block 0, Plane 1 may be writing Block 1. As another example, while Plane 1 is writing Block 3, Plane 0 may be writing Block 4. However, it is not required that the two blocks in the multi-plane command have an address that differs by one. For example, while Plane 0 is writing Block 0, Plane 1 may be writing Block 7. As another example, while Plane 0 is reading one its Blocks, Plane 1 may be reading one its Blocks. As still another example, while Plane 0 is erasing one its Blocks, Plane 1 may be erasing one its Blocks.

Assume for the sake of discussion that Plane 1 is defective in the device in FIG. 2B. For the sake of example, also assume that there are the same number of blocks per plane in the examples in FIG. 2A and 2B. A comparison of how blocks are numbered in FIG. 2A and 2B shows that blocks in Plane 0 in FIG. 2B do not have the same numbering as the blocks in the single plane example of FIG. 2B. Thus, the memory controller 122 cannot simply attempt to access Block 0, Block 1, Block 2, . . . Block p, without some address translation in the memory package 142. For example, were the memory controller 122 to attempt to access a block with an odd address, it would be attempting to access the defective plane. Embodiments disclosed herein perform an address translation to allow the memory controller 122 to simply send a single plane command to a memory package 142 having a defective plane. Thus, as one example, to the memory controller 122 it appears as though it is working with a single plane device, as depicted in FIG. 2A, when in fact the memory package is a two plane device such as in FIG. 2B. The foregoing is just one example for the sake of illustration.

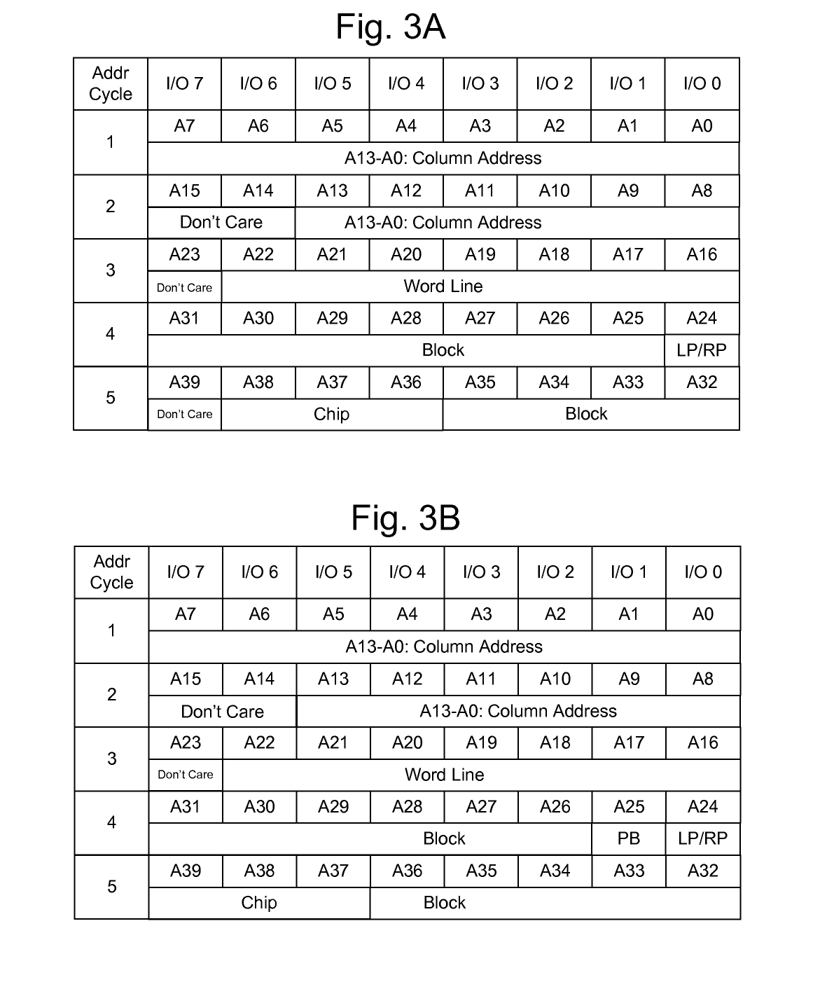

FIG. 2C depicts a diagram of another embodiment of a blocks in a single-plane memory die 108. In this example, the plane is conceptually (or logically) divided into a left plane (having even numbered blocks) and a right plane (having off numbered blocks). This does not necessarily represent a physical division of the plane into two regions. Rather, this is logical. This example will be discussed in more detail with respect to the example single plane mapping of FIG. 3A. Thus, FIG. 2C is included to help better explain the example single plane mapping of FIG. 3A.

FIG. 2D depicts a diagram of another embodiment of a blocks in a multi-plane memory die 108. The multi-plane memory die 108 also has two planes 202 (Plane 0, Plane 1). However, in this example, Plane 0 has Blocks 0, 1, 4, 5, 8, 9, 12, 13, . . . n, n+1. Plane 1 has Blocks 2, 3, 6, 7, 10, 11, 14, 15, . . . n+2, n+3. Again, the block addresses are interleaved between the two planes. However, in this example, there are two sequential blocks in plane 0, then two sequential blocks in plane 1, etc. Also, there could be more than two planes 202. For example, there might be four, eight, or some other number of planes 202.

In the examples of FIG. 2B and 2D, the controller 122 may send a multi-plane command to the memory package 142 (see FIG. 1C) to take advantage of the parallelism. The multi-plane command may instruct the memory package 142 to perform operations in parallel in plane 0 and plane 1. For example, a multi-plane read command may instruct the memory package 142 to perform a read at a specified address of plane 0, in parallel with a read at a specified address in plane 1.

Note that the single plane memory die 108 of FIG. 2A is for sake of illustration. Embodiments described herein solve problems when a plane in a multi-plane memory die 108 is defective. However, to the controller 244, a multi-plane memory die 108 might appear to be a single plane memory die. This will be explained in more detail below.

Next, note that conventionally all of the die 108 of a memory package 142 might be manufactured with a single plane, or alternatively, all of the die 108 of a memory package 142 might be manufactured with two planes (or all die having four planes, etc.). For example, referring to FIG. 1C, conventionally, all of the die 108 might have a single plane. Alternatively, conventionally, all of the die 108 in FIG. 1C might have a multiple-planes. As noted above, embodiments described herein solve problems when a plane in a multi-plane memory die 108 is defective. In some embodiments, when one of the die 108 has a defective plane, all of the die in the memory package 142 are operated as single plane die. For example, referring to FIG. 1C, if one of the die 108 attached to the controller 122 has a defective plane, then all of the die 108 attached to the controller 122 are operated as single plane die. In one embodiment, this is on a per memory pack 142 basis. For example, if one of the die 108 in a given memory package 142 has a defective plane, then all of the die 108 in that given memory package 142 are operated as single plane die. The memory controller 122 need not even be aware that the die 108 have multiple planes. Thus, from the perspective of the memory controller 122, each of the die 108 in the given memory package 142 appears to have a single plane, in this example.

FIG. 3A is an example memory mapping scheme for a single-plane memory configuration. This could be used, for example, for a memory package 142 that has a single plane (per memory die) and 32 GB storage. FIG. 3B is an example memory mapping scheme for a multi-plane memory configuration. This could be used, for example, for a memory package 142 that has a two planes (per memory die) and 64 GB storage. The total amount of storage is just for the sake of illustration.

Referring now to the example single plane memory mapping in FIG. 3A, the mapping is divided into five address cycles, each with eight bits. The eight bits refer to an eight bit address/data bus between the memory controller 122 and the memory package 142. The individual lines of the address/data bus are referred to as I/O 0, I/O 1, I/O 2, I/O 3, I/O 4, I/O 5, I/O 6, and I/O 7. In general, the mapping is divided into: column address (A0-A13), word line address (A16-A22), LP/RP (A24), block address (A25-A35) and a chip address A36-A38. The word line address could also be called a page address. The chip address could also be referred to as a logical unit number (LUN). Note that there are some don't care bits (e.g., A14, A15, A23, A39), which are not used to specify the address. In this example, bit A24 (LP/RP) refers to “left plane/right plane”. This refers to the example addressing scheme depicted in FIG. 2C in which Blocks 0, 2, 4, etc. are depicted in a left portion of the plane, and Blocks 1, 3, 5, etc. are in a depicted in a right portion of the plane. This depiction refers to a logical division, and it not intended to represent an actual physical location. That is, the plane 202 is not necessarily divided into a physical left portion containing even blocks, and physical right portion containing odd blocks.

Referring now to the example multi-plane memory mapping in FIG. 3B, the mapping is also divided into five address cycles, each with eight bits. In general, the mapping is divided into: column address (A0-A13), word line address (A16-A22), LP/UP (A24), plane bit (PB) (A25), block address (A26-A36) and a chip address A37-A39. Note that there are only three don't care bits (A14, A15, A23) versus the four don't care bits for the single plane address mapping. In other words, one additional bit is used to specify the address. As noted above, the example multi-plane memory mapping could be used for a 64 GB device, whereas the example multi-plane memory mapping could be used for a 32 GB device.

There are some similarities between the two examples, which may reflect the underlying architecture of the memory packages 142. For example, both examples uses the same number of bits for the column address, the same number of bits for the word lines address, the same number of bits for the block address, and the same number of bits for the chip address. These similarities may reflect similar factors, such as the same number of blocks per plane, same number of word lines per block, etc.

However, there are some key differences between the two example memory mappings. The example multi-plane memory mapping in FIG. 3B uses A25 to indicate whether the command is for Plane 0 or Plane 1. Of course, the example single plane memory mapping does not need a bit for the plane address. A second difference is that the block address is shifted one bit higher in the example multi-plane memory mapping in FIG. 3B, relative to the single-plane memory mapping depicted in FIG. 3A. Another difference is that the chip address is shifted one bit higher in the example multi-plane memory mapping FIG. 3B, relative to the single-plane memory mapping depicted in FIG. 3A.

Note that FIG. 3A and 3B are just examples. In one embodiment, the general sequence of: column address, word line address, (plane address if used), block address, chip address is followed. However, many variations are possible. For example, the memory mapping for a memory device with the same amount of memory could have one less bit for the column address, but one more bit for the word line address. Another example variation would be to have more or fewer blocks per plane, leading to more or fewer bits for the block address. Also, there could be more or fewer don't care bits, and the location of the don't care bits could be different. Many other variations are possible. Also, the LP/RP bit (A24) might be replaced with another bit that is labeled as a Block address. Referring to the examples of FIG. 2C and 2D, note that the LP/RP bit (A24) contains information that specifies the block number. For example, in FIG. 2C, the LP/RP bit (A24) may define whether the block number is even or odd.

The examples of FIG. 3A and 3B are for one-plane and two-planes, to help explain various embodiments. However, note that similar problems can plague multi-plane memory devices with other numbers of planes, such as, but not limited to, a four-plane memory device. Thus, it will be understood that embodiments described herein may be applicable to memory devices that were manufactured with two or more planes per die.

As mentioned already, sometimes during testing of a multi-plane memory device, it is determined that one plane is defective. Moreover, the defect to the plane may be so severe that it is not suitable for storing data. Since the memory device (in this example) was designed to have two-planes, this has implications for the memory mapping scheme. The memory mapping does not change simply because one plane is defective, in accordance with embodiments. In other words, the memory mapping does not change from the two plane mapping to the one-plane memory mapping when one plane of a multiple-plane device is defective, in accordance with embodiments. As another example, the memory mapping does not change from a four-plane mapping to a two-plane memory mapping when one plane of a multiple-plane device is defective, in accordance with embodiments.

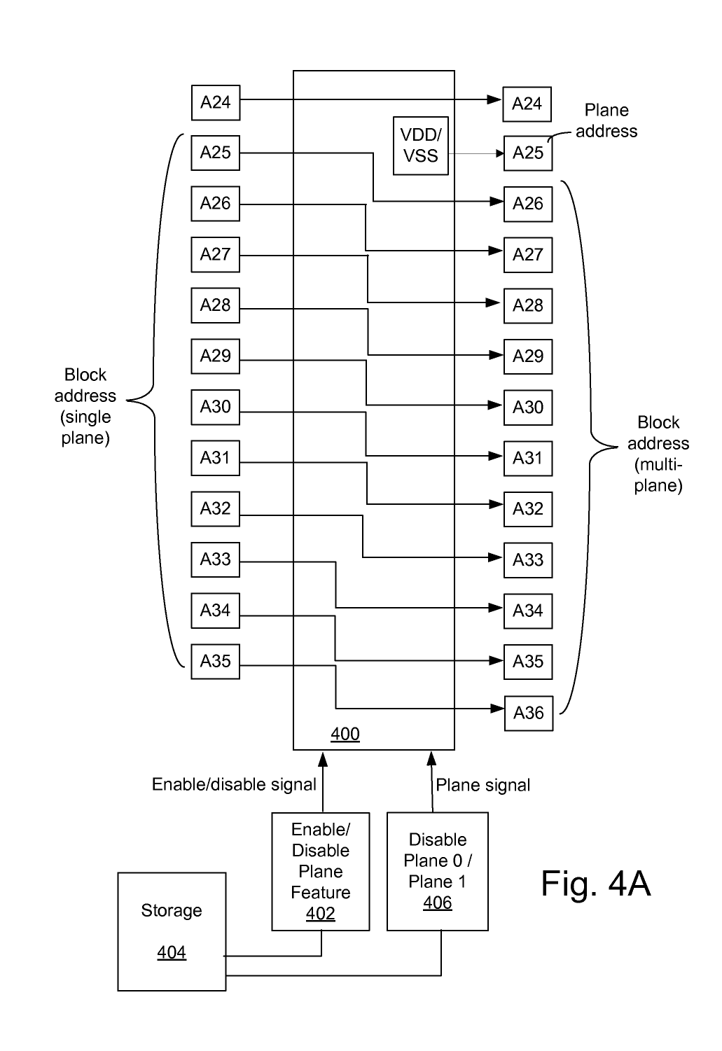

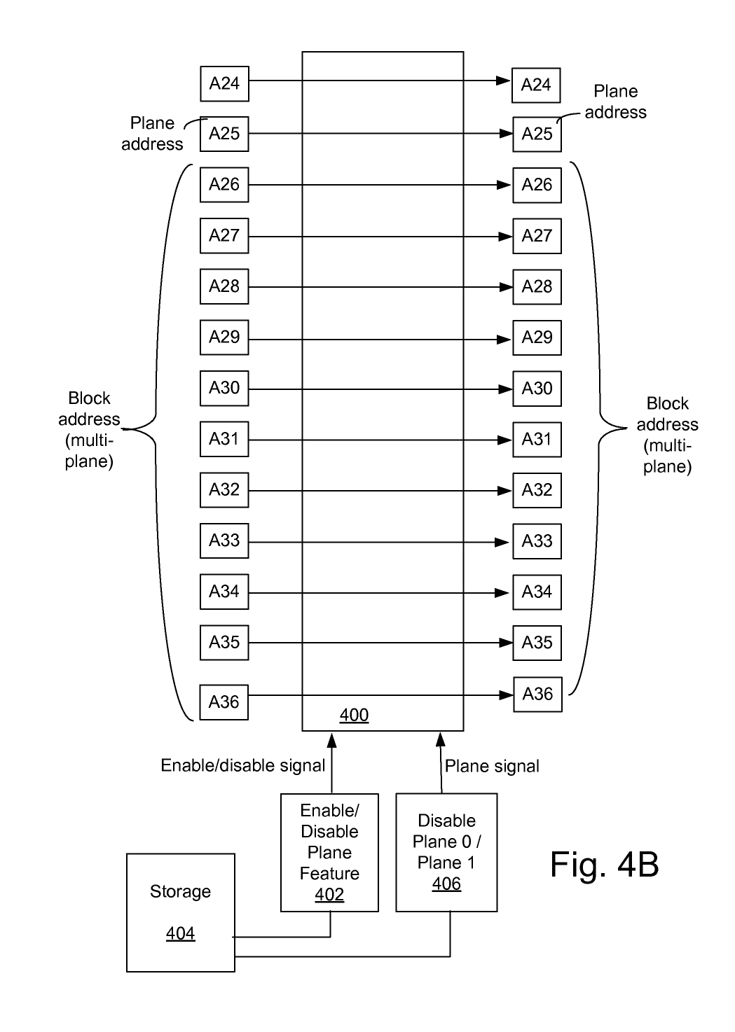

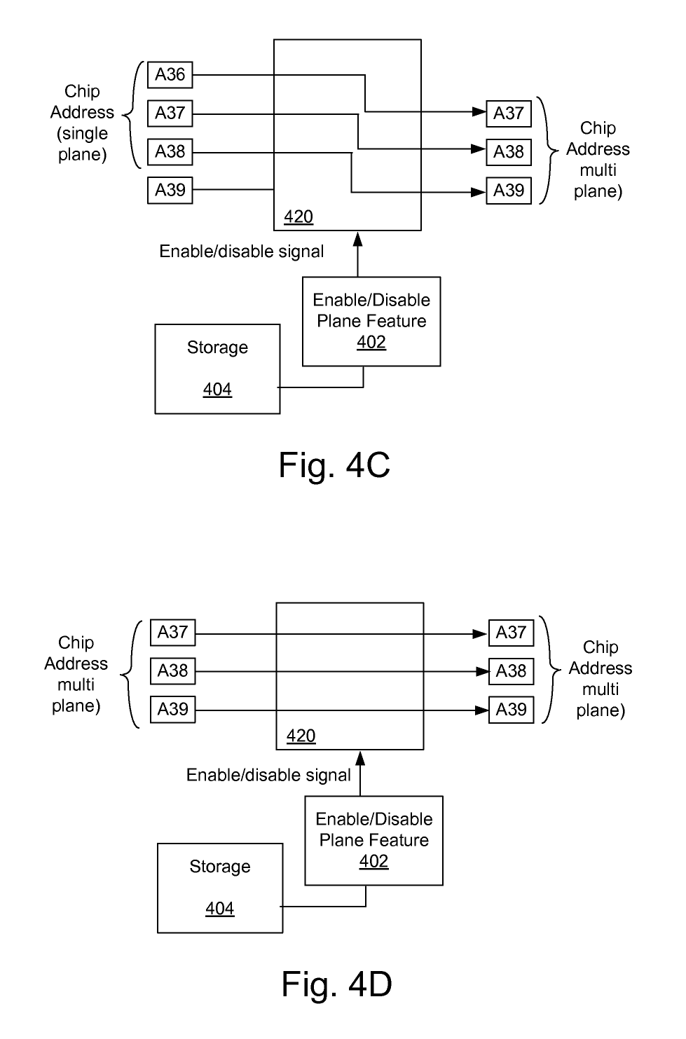

One embodiment includes circuitry that translates an address from a single plane command that may be received from a memory controller 122 such that it is suitable for a multi-plane address mapping. FIG. 4A shows a block diagram of one embodiment of an address translation unit 400 and associated elements. The address translation unit 400 may be part of the on-chip address decoder (FIG. 1B, 114). The address translation unit 400 of FIG. 4A is consistent with the example mappings of FIGS. 3A and 3B, in accordance with embodiments. The address translation unit 400 performs a translation from the mapping of FIG. 3A to the mapping of FIG. 3B. The address translation unit 400 can be modified to accommodate other mappings. In one embodiment, the address translation unit 400 may be implemented in hardware, such as but not limited to, registers, latches, digital logic, etc.

The address translation unit 400 may be enabled or disabled by enable/disable plane feature logic 402. For example, if it is determined when the memory device was manufactured that there is a plane that is defective, then information may be stored in the memory device indicating that the plane feature should be enabled during operation. FIG. 4A depicts storage 404 for this purpose. Storage 404 can be implemented anywhere on the memory device. For example, storage 404 could be part of storage device (FIG. 1B, 126a), ROM (FIG. 1B, 122a), parameters (FIG. 1B, 113), but is not limited to these examples. Enable/disable plane feature logic 402 can be implemented by, but is not limited to, state machine 112, processor 122c, digital logic, etc.

The plane feature is enabled by providing an enable/disable signal to the address translation unit 400, in one embodiment. Thus, logic 402 may access storage 404 to determine whether the plane feature should be enabled. The logic 402 may provide, for example, a value of “0” or “1” to enable/disable the plane feature.

FIG. 4A also depicts disable Plane 0/Plane 1 logic 406 for disabling plane 0 or plane 1. This logic 406 may access storage 404 to determine which plane should be disabled and provide a plane signal to the address translation unit 400 accordingly. Thus, the address translation unit 400 has an input that can be used to specify which plane is disabled (assuming the plane feature is enabled). For example, if logic 406 determines that plane 1 is defective, then the plane signal is sent with a value to instruct address translation unit 400 to disable plane 0. In one embodiment, the information that specifies which plane (if any) is disabled is stored in non-volatile storage. Note that the foregoing example of two planes may be extended to a greater number of planes. Thus, the plane signal might indicate that planes 2 and 3 are disabled, whereas planes 0 and 1 and enabled. This could be used when either plane 2 or plane 3 is defective. Disable Plane 0/Plane 1 logic 406 can be implemented by, but is not limited to, state machine 112, processor 122c, digital logic, etc.

The address translation unit 400 inputs 11 block address bits (e.g., A25-A35) in this example. Similarly, the address translation unit 400 outputs 11 block address bits (e.g., A26-A36). In other embodiments, there are more or fewer than 11 block address bits. The address translation unit 400 also outputs a plane address bit (output A25). In other embodiments, there could be two or more plane address bits. The value for the plane address bit (output A25) reflects which plane is selected, in one embodiment. The value for the plane address bit may be generated a variety of ways. As one example, plane 0 could be represented by logic low and plane 1 by logic high. In other words, plane 0 could be represented by a low voltage and plane 1 by high voltage. The memory device may have readily available voltage values that are used for other purposes that can be used. For example, a voltage (V_{DD}) that is normally used to supply a drain side of transistors could be used for the logic high and a voltage (V_{SS}) that is normally used to supply a source side of transistors could be used for the logic low. Many other possibilities exist.

The address translation unit 400 receives address bits from the single plane command, in this example. In this example, these are the block address bits A25-A36 from the example of FIG. 3A. For example, the memory controller 122 may send a single plane command, from which block address bits A25-A36 are extracted and provided to address translation unit 400. These are labeled as “block address (single plane)” in FIG. 4A.

The address translation unit 400 shifts each of bits A25-A36 one bit higher, in this example. For example, A25 is shifted to A26, A26 is shifted to A27, etc. The output is labeled as “block address (multi plane)” in FIG. 4A. This shifting indicates that the output block address is compliant with the multi-plane address mapping of FIG. 3B. The output block address is provided to row decoders, in one embodiment. Thus, note that the row decoders may receive a shifted version of the block address bits from the single plane command.

Also, bit A24 is passed through address translation unit without modification in this example. Referring to FIGS. 3A and 3B, A24 is the LP/RP bit. Recall this is to specify a logical left plane or logical right plane, as depicted in FIGS. 2C and 2D. This bit does not need to be shifted, as will be explained below in a detailed example. Note that this bit, as well as the plane address bit (A25) may also be provided to the row decoders.

The row decoders may be configured to select the proper plane and block in accordance with the address received by the row decoders. As noted above, FIG. 4A shows an example for the address mappings of FIGS. 3A and 3B. The address translation unit 400 may be modified to accommodate other address mappings from single plane to multi-plane.

Note that when the plane feature is not enabled, there is not any shifting of the bits of the address. As noted, the plane enable feature may be enabled when there is a defective plane. When no plane is defective, the memory package 142 may be operated as a multi-plane device. Thus, the memory controller may send a multi-plane command. For example, the memory controller sends multi-plane commands that are compliant with the address mapping depicted in FIG. 3B. In this case, there is no need to shift the address bits. Thus, the memory package 142 may simply supply the address bits from the multi-plane command to the address decoders. This is depicted in the example of FIG. 4B. For example, address bits A24-A36 from a multi-plane command could be sent to the row decoders without any shifting. The row decoders may be configured to select the proper plane and block in accordance with the received address.

FIG. 4C is a block diagram of chip address logic 420 that performs an address translation for a chip address. This example also pertain to the example mappings of FIGS. 3A and 3B. The chip address logic 420 may receive four bits (A36-A39) from a single plane command having the address mapping depicted in FIG. 3A. Bits A36-A38 are each shifted up one bit by the chip address logic 420 to comply with the multi-plane address mapping of FIG. 3B. Since A39 is not used in the single-plane address mapping of FIG. 3A, this bit does not convey any information when a single plane command is received. Hence, the chip address logic 420 does not output anything for this bit when the plane feature is enabled. Note that this assumes that when the plane feature is enabled that the memory controller will send a single plane command. Thus, this applies to the examples of FIGS. 3A and 3B. It is possible to extend this concept to a different number of bits for the chip address, as well as for having the chip address in different locations in the address mappings.

When the plane feature is not enabled, then the chip address logic 420 need not perform any bit shifting. This is depicted in FIG. 4D. As with the block address example just discussed, the memory controller may send a multi-plane command if the memory device is operating as a multi-plane device. In this case, the memory device may simply use the chip address bits (or LUN) from the multi-plane command. For example, address bits A37-A39 from a multi-plane command could be used without any shifting. The memory device may be configured to select the proper chip (or LUN) based thereon.

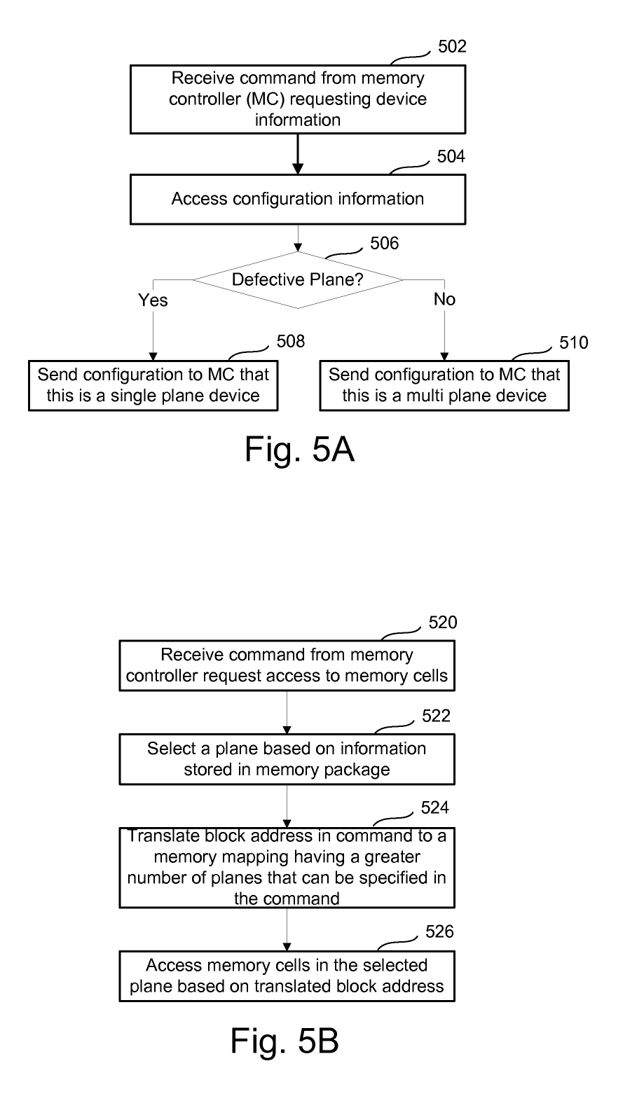

In one embodiment, the memory package 142 informs the memory controller 122 whether it is operating as a single plane or multi-plane device. This may be performed in response to a request for information from the memory controller 122. FIG. 5A is a flowchart of one embodiment of a process of informing a memory controller 122 that there is a plane that is disabled. In step 502, a command is received from the memory controller 122 requesting device information. In one embodiment, the command is received from the memory controller 122 over lines 118 (see FIG. 1B). Referring to FIG. 1C, the command might be received by any of the memory packages 142. In one embodiment, the command is received by a NAND device. In one embodiment, the command is compliant with a Read ID command of a version of the Open NAND Flash Interface (ONFI) Specification. The ONFI Specification describes a standardized NAND flash device interface. However, the command is not required to be compliant with any version of the ONFI Specification. Also, a different command in the ONFI Specification might be used. Moreover, the memory package is not required to include a NAND memory structure. Hence, the interface to the memory package is not required to be a NAND interface.

In step 504, configuration information is accessed in order to respond to the command from the memory controller. Step 504 may be performed by logic on the memory package 142. The configuration information may be stored anywhere on the memory package. For example, it might be stored in storage device 126a, parameters 113, or elsewhere. The configuration information may indicate whether any of the planes in the memory package are defective. The configuration information may indicate whether this is a single plane device, two plane device, four plane device, etc. The configuration information could specify what type of device this is. For example, a manufacturer might have several unique device IDs that correspond to devices having certain configurations. As a specific example, a device with a certain ID might be a single plane device with 32 GB of memory; a device with another ID might be a two plane device with 64 GB of memory.

Based on the stored configuration information, either step 508 or step 510 is performed to indicate whether the memory package 142 is a single plane device or multi-plane device. Note that in step 510, the response could be that the device is operating as a two-plane device, four-plane device, etc. In one embodiment, the memory package 142 sends a response to a Read ID command that is compliant with a version of the ONFI Specification. This response may specify a device ID. The memory controller 122 is able to determine whether this is a single plane device or a multi-plane device, based on the device ID, in one embodiment. However, the response to the controller need not be compliant with any version of the ONFI specification.

Note that a variation of FIG. 5A is to report whether the memory package is operating as either a two-plane device or a four-plane device. For example, when there is not a defective plane the memory package reports that it is a four-plane device; however, when there is a defective plane the memory package may report that it is a two-plane device. Still another variation is to report whether the memory package is operating as either a four-plane device or an eight-plane device. For example, when there is not a defective plane the memory package reports that it is an eight-plane device; however, when there is a defective plane the memory package may report that it is a four-plane device. Other possibilities exist.

FIG. 5B is a flowchart of one embodiment of a process of accessing memory cells in a memory package in which a plane is disabled. The memory package comprises a memory die having a number of planes. This may apply to memory package having two, four, or more planes.

Step 520 includes receiving a command from a memory controller to access non-volatile storage elements in a memory package. The command comprises a block address. This might be a single plane command or a multi-plane command. The single plane command need not specify a plane. The multi-plane command may specify one plane out of two possible planes, four possible planes, eight possible planes, etc.

Step 522 includes selecting one of the planes on the memory package based on information stored in the memory package. Thus, the selection may be based on information not in the command. This may be based on information stored on the memory package that indicates which plane(s) are defective, which are operational, etc. In one embodiment, step 522 includes adding at least one bit of information to the received address in order to specify the plane. FIG. 4A shows a circuit for one embodiment.

Step 524 includes translating the block address from the command to a memory mapping having a greater number of planes than can be specified in the command. For example, the command may be a single plane command that does not specify a plane, in which case the memory mapping may be a two-plane memory mapping. For example, the command may be a multi-plane command that has one bit of information to specify one out of two planes, in which case the memory mapping may be a four-plane memory mapping. For example, the command may be a multi-plane command that has two bits of information to specify one out of four planes, in which case the memory mapping may be an eight-plane memory mapping. Note that in each example, an extra bit of information is needed to specify the plane than is provided in the command. This extra bit of information may be stored on the memory package in the form of information that indicates which plane is defective. In one embodiment, step 524 includes shifting bits in a block address to perform the address translation.

In step 526, the non-volatile storage elements in the selected plane are accessed based on the translated block address. For example, non-volatile storage elements are read, written, or erased. Note that step 526 includes executing in different planes in parallel. For example, two or or four planes in the die might be read in parallel.

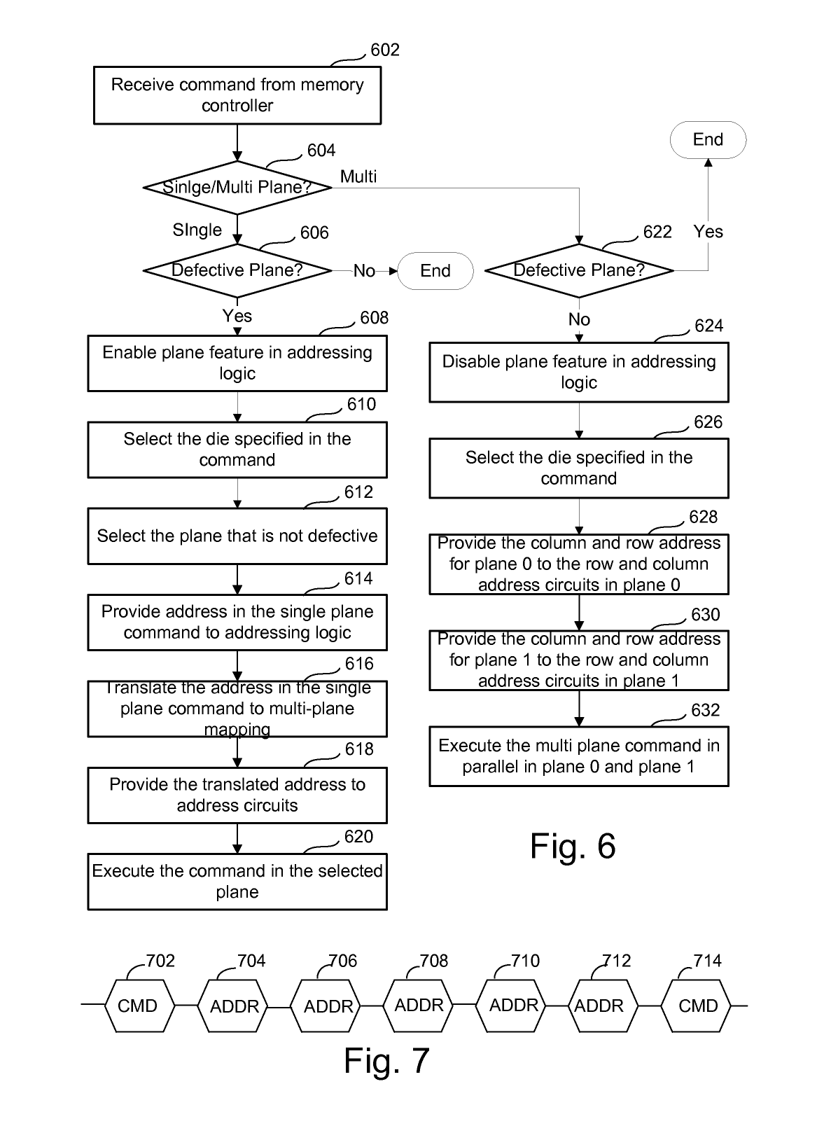

FIG. 6 is a flowchart of one embodiment of a process of operating a memory device. This is one embodiment of the process of FIG. 5B. In this embodiment, the memory package 142 has been manufactured with two planes per die 108. In this process, the memory package 142 might or might not have a defective plane. Hence, this memory package 142 might operate as a single plane device (at least one plane is defective) or as a multi-plane device (no planes defective). For the sake of discussion, the memory controller 122 might send a single plane command or a multi-plane command in either scenario.

In step 602, a command is received from the memory controller 122. In one embodiment, the command is received over pins that are designated as I/O pins. For example, eight pins on the memory package 142 (containing one or more die 108) may be designated as I/O pins. The command may be divided into a number of cycles. This could be divided into one or more cycles for specifying the command and a number of cycles for specifying the address. FIG. 7 depicts one possible way to organize sending the command. Each cycle (702-714) represents what is sent over the I/O lines at one point in time. The first cycle 702 is a command cycle. This may specify whether the command is a read, write, erase, or some other command. An assumption will be made for purposes of discussion that this is either a read, write, or erase command. The next five cycles 704-712 are for the address. These five cycles correspond to the five address cycles in FIG. 3A for a single plane command and FIG. 3B for a two-plane command, in embodiments that use those mappings. However, as already discussed, those are example mappings, and the address cycles 704-712 are not limited to those examples. There could be more or fewer than five address cycles. Cycle 714 is a second command cycle. This may be used to specify whether the command is single plane or multi-plane. In one embodiment, a single plane command and multi-plane command are compliant with a version of the ONFI specification. However, it is not required that the commands be compliant with any version of the ONFI specification.

Note that if the command is a multi-plane command, then what is sent in the address cycles depicted in FIG. 7 is for one plane. The controller 122 may then send additional information to specify the address for the next plane. The format for this additional information may be similar to the two cycles for the command with five cycles for the address that is depicted in FIG. 7.

In step 604, the memory package 142 determines whether this is a single plane or multi-plane command. If this is for a single plane command, then the memory package 142 determines whether there is a defective plane in the memory package 142, in step 606. For example, the memory package 142 determines whether it has multiple planes per die but is operating as a single plane device. If so, then the memory package 142 performs steps 608-620. In one embodiment, enable/disable plane feature logic 402 accesses storage 404 to make this determination. However, other logic could access the storage 404 to make this determination.

In step 608, the memory package 142 enables the plane feature. In one embodiment, enable/disable plane feature logic 402 provides enable/disable signal to address translation unit 400 to enable the plane feature.

In step 610, the die (or LUN) that is specified in the single plane command is selected. Referring to FIG. 4C, this may include the enable/disable plane feature sending a signal to the chip address logic 420 to enable the plane feature. The chip address logic 420 may perform the address shifting that is depicted in FIG. 4C. In this manner, the proper chip may be selected.

In step 612, the plane that is not defective is selected. Stated another way, the operational plane is selected. In one embodiment, disable plane 0/plane 1 logic 406 provides plane signal to address translation unit 400 to select the plane that is not defective. This may also be referred to as disabling the plane that is defective (or non-functional). The selection may be based on information that is not in the commands. This step may be performed without regard for any information in the single plane command. Instead this step may be based entirely on information stored on the memory package. For example, logic 406 may access stored information that indicates which plane is operational, which plane is not operational, etc.

In step 614, the address in the single plane command is provided to the address translation unit 400. As one example, address bits A24-A35 from the single plane command are provided to address translation unit 400. Referring to FIG. 3A, these are all of the bits in the fourth address cycle and the bits on I/O 0 through I/O 3 in the fifth address cycle. As already noted, this is just one example. Note that the column portion of the address, the word line portion of the address, and the chip portion of the address may be handled elsewhere.

In step 616, the address in the single plane command is translated to a multi-plane mapping. In one embodiment, address translation unit 400 performs this translation. An example was described with respect to FIG. 4A, but step 616 is not limited to that example. Step 616 may include generating a plane address, even though there is not a plane address in the single plane command.

In step 618, the translated address is provided to address decoders. In the embodiment depicted in FIG. 4A, address bits A24-A36, which are output by address translation unit 400 are provide to address decoders. Note that other portions of the address in the single plane command (e.g., column and word line portions) may also be provided to address decoders. In one embodiment, step 618 provides the translated address, as well as the word line portions to row decoders 124. The column portion of the address may be provided to column decoders 132.

In step 620, the command is executed in the selected plane. For example, a single plane read command is performed in the selected plane. Alternatively, a single plane write, or a single plane erase is performed in the selected plane. The single plane command is not limited to these examples.

On the other hand, if in step 606 the memory package 142 determines that it is not operating as a single plane device when it receives a single plane command, then alternative steps may be taken. In one embodiment, when the memory package operates as a multi-plane device it does not expect to receive a single plane command. Hence, the memory package may send a response to the memory controller that the single plane command cannot be executed. However, this is just one option.

Next, the case in which the memory controller 122 sends a multi-plane command will be discussed. Thus, if the memory package 142 determines that the command is a multi-plane command, control passes to step 622. When a multi-plane command is received in this embodiment, the memory package 142 does not expect for there to be a defective plane. Stated another way, when a multi-plane command is received in this embodiment, the memory package 142 expects that it is operating as a multi-plane device and not as a single-plane device. In step 622, the memory package 142 determines whether there is a defective plane. An alternative way of expressing this step in this embodiment is that the memory package 142 determines whether it is operating as a single plane or multi-plane device. If it determines that there is a defective plane, then the process ends. One option here is to send a response to the memory controller that indicates that a multi-plane command is not expected (due to the memory package 142 operating as a single plane device). However, this is just one option.

Assuming that the memory package 142 does not have a defective plane, then control passes to step 624. Since this is a multi-plane command, it will be assumed that the memory package 124 received an address for plane 0 and another address for plane 1. Referring to FIG. 7, the memory controller 122 may send one such sequence for each plane.

In step 624, the plane feature is disabled. In one embodiment, the enable/disable plane feature logic 402 provides a signal to the address translation unit 400 to instruct it to disable the plane feature. Note that the address translation unit 400 may ignore the plane signal (which may be used to specify the defective plane) when the plane feature is disabled. When the plane feature is disabled, the address translation unit 400 simply passes the addresses through, without any shifting.

The die (or LUN) may also be specified in the multi-plane command. It will be assumed that plane 0 and plane 1 are on the same die. In step 626, the memory package 142 selects the die specified in the multi-plane command. Referring to the example circuit in FIG. 4D, the enable/disable plane feature logic 402 disables the plane feature (via enable/disable signal) by sending the correct signal to the chip address logic 420. The chip address logic 420 may simply pass the address through in this case. Note that when the plane feature is disabled, all bits A0-A39 may be un-shifted. Referring back to the example in FIG. 3B, the shifting of bits A36-A38 does not occur when the plane feature is disabled.

In step 628, the address for plane 0 is provided to address circuits for plane 0 in the selected die.

In step 630, the address for plane 1 is provided to address circuits for plane 1 in the selected die.

In step 632, the multi-plane command is executed in parallel in plane 0 and plane 1 in the selected die.

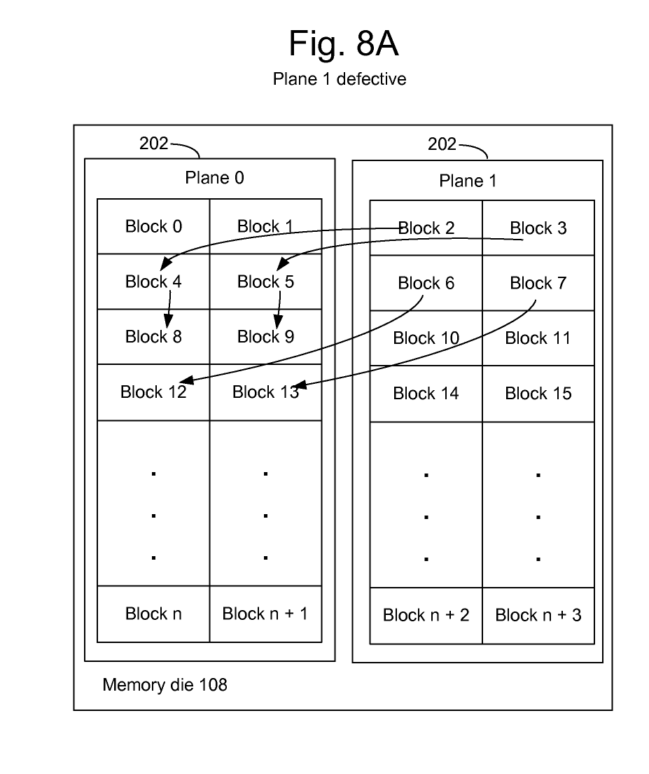

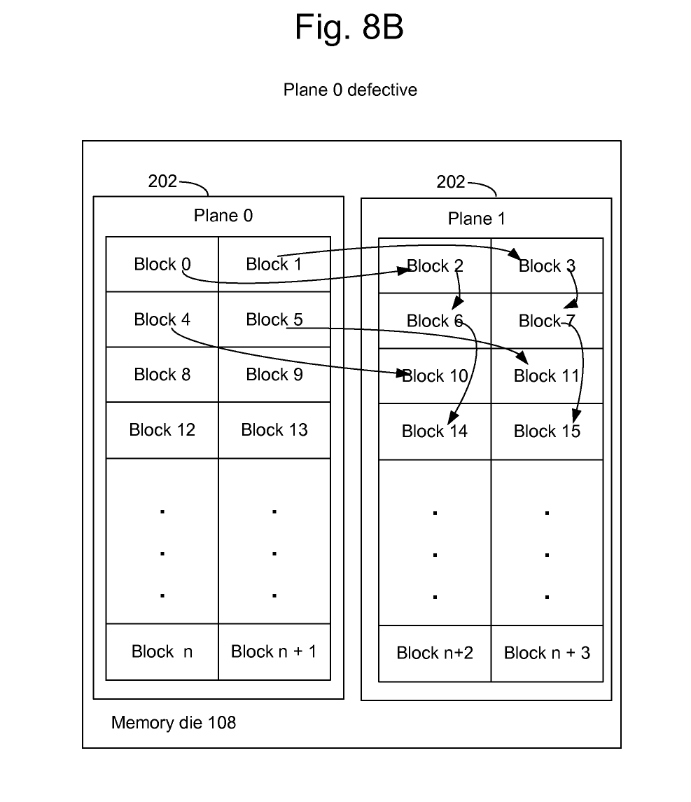

FIG. 8A shows a mapping example in accordance with one embodiment. In this example, Plane 1 is defective and Plane 0 is operational in the memory die 108. In this example, the memory mapping is similar to the mapping of FIG. 2D in which Plane 0 has Block 0, Block 1, Block 4, Block 5, etc.; and in which Plane 1 has Block 2, Block 3, Block 6, Block 7, etc. This example is consistent with the example memory mappings of FIG. 3A and 3B.

FIG. 8A shows how blocks in the defective plane may be mapped to blocks in the operational plane. FIG. 8A also shows how blocks in the operational plane may be re-mapped to other blocks in the operational plane. For example, Block 2 in the defective Plane 1 is mapped to Block 4 in the operational Plane 0, Block 3 in the defective Plane 1 is mapped to Block 5 in the operational Plane 0, Block 6 in the defective Plane 1 is mapped to Block 12 in the operational Plane 0, and Block 7 in the defective Plane 1 is mapped to Block 13 in the operational Plane 0. Block 4 in the operational Plane 0 is mapped to Block 8 in the operational Plane 0, and Block 5 in the operational Plane 0 is mapped to Block 9 in the operational Plane 0.

Note that when mapping from two planes to one plane, the total number of blocks may be cut in half. However, when the controller 122 is informed that the memory package is being operated as a single plane device, the controller 122 may be informed of the total number or blocks and/or total amount of memory per die. Hence, the controller 122 will know that it should not attempt to address blocks such as Block n or Block n+2.

The following mapping example depicts how the shifting of the address by the address translation unit 400 may achieve the mapping depicted in FIG. 8A. This example is consistent with the address translation unit 400 in FIG. 4A and the mappings in FIGS. 3A and 3B. In this example, Plane 0 is selected (e.g., Plane 1 is defective). Bit A24 is not shifted, hence its received value is the same after translation. Translated Bit A25 is the Plane address bit. Hence, its value is 0 to indicate Plane 0 is selected. Received Bits A25 and A26 are each shifted up one bit to Translated bits A26 and A27, respectively. To simplify the example, the shifting of bits A27-A35 is not depicted in this example.

Plane 0 Selected

| Received | | | Translated | | | |
|---|---|---|---|---|---|---|
| A26 | A25 | A24 | A27 | A26 | A25 | A24 |
| 0 | 0 | 0 | 0 | 0 | 0 | 0 |
| 0 | 0 | 1 | 0 | 0 | 0 | 1 |
| 0 | 1 | 0 | 0 | 1 | 0 | 0 |
| 0 | 1 | 1 | 0 | 1 | 0 | 1 |
| 1 | 0 | 0 | 1 | 0 | 0 | 0 |
| 1 | 0 | 1 | 1 | 0 | 0 | 1 |
| 1 | 1 | 0 | 1 | 1 | 0 | 0 |
| 1 | 1 | 1 | 1 | 1 | 0 | 1 |

The three received bits (A26-A24) would map to the blocks depicted in FIG. 8A (without the remapping) if no address translation were to be performed. For example, if A26-A24 are “011”, then Block 3 in Plane 1 would be selected. However, this is the defective plane. The four bits (A27-A24) correspond to the block addresses after remapping. Thus, note that this example, A27-A24 are mapped to “0101”, which is Block 5. This is the mapping from Block 3 to Block 5 depicted in FIG. 8A. Thus, the address translation is able to allow the memory controller 122 to send a single plane command to a memory package 124 that is mapped as a multi-plane device without the memory controller 122 needing to be aware of the remapping. Furthermore, note that the result of mapping in FIG. 8A is to produce a mapping that resembles the example single plane mapping in FIG. 2C. Thus, to the memory controller, it appears as though it is working with a single plane memory device having the mapping of FIG. 2C.

FIG. 8B shows a mapping example when Plane 0 is defective and Plane 0 is operational. For example, Block 0 in the defective Plane 0 is mapped to Block 2 in the operational Plane 1, Block 1 in the defective Plane 0 is mapped to Block 3 in the operational Plane 1, Block 4 in the defective Plane 0 is mapped to Block 10 in the operational Plane 1, and Block 5 in the defective Plane 0 is mapped to Block 11 in the operational Plane 1. Block 2 in the operational Plane 1 is mapped to Block 6 in the operational Plane 1, Block 3 in the operational Plane 1 is mapped to Block 7 in the operational Plane 1, Block 6 in the operational Plane 1 is mapped to Block 14 in the operational Plane 1, and Block 7 in the operational Plane 1 is mapped to Block 15 in the operational Plane 1.

The following mapping example depicts how the shifting of the address by the address translation unit 400 may achieve the mapping depicted in FIG. 8B. This example is consistent with the address translation unit 400 in FIG. 4A and the mappings in FIGS. 3A and 3B. In this example, Plane 1 is selected (e.g., Plane 0 is defective). A difference between this example and the previous is that A25 is always “1” in the translated version due to Plane 1 being selected.

Plane 1 Selected

| Received | | | Translated | | | |
|---|---|---|---|---|---|---|
| A26 | A25 | A24 | A27 | A26 | A25 | A24 |
| 0 | 0 | 0 | 0 | 0 | 1 | 0 |
| 0 | 0 | 1 | 0 | 0 | 1 | 1 |
| 0 | 1 | 0 | 0 | 1 | 1 | 0 |
| 0 | 1 | 1 | 0 | 1 | 1 | 1 |
| 1 | 0 | 0 | 1 | 0 | 1 | 0 |
| 1 | 0 | 1 | 1 | 0 | 1 | 1 |
| 1 | 1 | 0 | 1 | 1 | 1 | 0 |
| 1 | 1 | 1 | 1 | 1 | 1 | 1 |

As with the previous example, the three received bits (A26-A24) would map to the blocks depicted in FIG. 8B (without the remapping) if no address translation were to be performed. For example, if A26-A24 are “100”, then Block 4 in Plane 0 would be selected. However, this is the defective plane. The four bits (A27-A24) correspond to the block addresses after remapping. Thus, note that in this example, A27-A24 are mapped to “1010”, which is Block 10. This is the mapping from Block 4 to Block 10 that is depicted in FIG. 8B. Thus, the address translation is able to allow the memory controller 122 to send a single plane command to a memory package 124 that is mapped as a multi-plane device without the memory controller 122 needing to be aware of the remapping. Again, note that the result of mapping in FIG. 8B is to produce a mapping that resembles the example single plane mapping in FIG. 2C. Thus, to the memory controller, it appears as though it is working with a single plane memory device having the mapping of FIG. 2C.

Concepts disclosed herein can be expanded beyond a single plane to two-plane mapping. In one embodiment, the memory package has a four plane mapping. That is, there are four planes per die. However, one (or two) of the planes may be defective. For example, the four planes may be numbered: Plane 0, Plane 1, Plane 2, Plane 3. For the sake of example, either Plane 2 or Plane 3 is defective. In this case, the device could be operated as a two plane device, with Plane 0 and Plane 1 operational. As another example, either Plane 0 or Plane 1 might be defective. In this case, the device could be operated as a two plane device, with Plane 2 and Plane 3 operational.

Thus, in the foregoing example, the memory package may send a command to the memory controller that indicates it is operating as a two-plane device. The memory controller may send two-plane commands to the memory package. From the perspective of the memory controller, the memory package may appear to be a two plane device. The memory package has an address translation unit in this embodiment that performs the address translation from the two plane address to the four plane address.

Note that in the foregoing example, the two-plane commands to the memory package may have a single bit to specify the plane. The memory package may add one bit of information to this for final plane selection. For example, the two-plane commands may specify either Plane 0 or Plane 1. The memory package may add one bit of information to specify one of Plane 0, Plane 1, Plane 2, or Plane 3. For example, if plane 2 is defective, then the memory package may add one bit to select either Plane 0 or Plane 1. If plane 1 is defective, then the memory package may add one bit to select either Plane 2 or Plane 3.

Referring back to FIG. 4A, circuit 400 could input a two-plane address that includes one bit for the plane. The plane signal that is output by logic 406 could be used to either disable Plane 0 and Plane 1, or alternately, disable Plane 2 and Plane 3. This selection may occur in a similar manner to how VDD/VSS is used to create the information for A25 that is output by circuit 400. The bit of information in the two-plane command may be used to select between Plane 0 and Plane 1 in the event that Plane 2 and Plane 3 are disabled. The bit of information in the two-plane command may be used to select between Plane 2 and Plane 3 in the event that Plane 0 and Plane 1 are disabled.

Thus, the memory package selects the plane based on information that is not in the command. This information may be the information that is stored on the memory package that indicates which plane(s) is defective or, alternatively, which plane(s) are to be used in operation. Note that in this example, a functional plane might not be used. For example, if plane 2 is defective, both planes 2 and 3 might not be used in operation. Thus, both planes 2 and 3 can be disabled.

The teachings herein can be applied to memory die with even more than four planes. For example, an eight plane memory die with a defective plane might be operated as a four-plane device. Of course, the eight plane memory die with a defective plane might be operated as a two-plane device, or even a single-plane device. Likewise, a four-plane memory die with a defective plane might be operated as a single-plane device.

One embodiment disclosed herein includes a non-volatile storage device comprising a memory die having a plurality of planes including a first plane and a second plane, and an address translation unit coupled to the plurality of planes. Each of the planes comprises blocks of non-volatile storage elements. The memory die has an interface that is configured to receive commands to access the non-volatile storage elements. The address translation unit is configured to disable one of the first plane or the second plane while selecting the other of the first plane or the second plane based on information stored on the non-volatile storage device that indicates which of the plurality of planes is defective. The address translation unit is configured to translate block addresses from associated commands that are received on the interface to an appropriate block of the selected one of the first plane or the second plane. The memory die is configured to access non-volatile storage elements in the selected plane based on the translated block addresses.

One embodiment disclosed herein includes a method comprising the following. A command is received from a memory controller to access non-volatile storage elements in a memory package. The memory package comprises a memory die having a plurality of planes. The command comprises a block address. One of the plurality of planes is selected based on information stored on the non-volatile storage device that indicates which of the plurality of planes is defective. The block address is translated from the command to a memory mapping having a greater number of planes than can be specified in the command. The non-volatile storage elements in the selected plane is accessed based on the translated block address.

One embodiment disclosed herein includes a method comprising receiving single-plane commands from a memory controller at an interface of a memory device. The memory device comprises a memory die having a first plane and a second plane. The single-plane commands each comprise a block address. The method further comprises disabling one of the first plane or the second plane, while selecting the other of the first plane or the second plane. The method further comprises translating block addresses from associated single plane commands that are received on the interface to an appropriate block of the selected one of the first plane or the second plane. The method further comprises providing the translated block addresses to an address decoder associated with the selected plane.

One embodiment disclosed herein includes a non-volatile storage device comprising a three-dimensional array of non-volatile storage elements, a memory controller, an interface that is configured to receive commands from the memory controller, and an address translation unit coupled to the three-dimensional array. The three-dimensional array comprises a first plane and a second plane of blocks of the non-volatile storage elements. The three-dimensional array comprises address decoders. The address translation unit is configured to select the first plane responsive to a determination that the second plane is not operational, translate an address from a single plane command that is received on the interface to a multi-plane mapping that comprises a plane address, including setting the plane address to the first plane, and provide the translated address to the address decoders of the three-dimensional array.

Corresponding methods, systems and computer- or processor-readable storage devices which have executable code for performing the methods provided herein may also be provided.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application, to thereby enable others skilled in the art to best utilize the invention in various embodiments and with various modifications as are suited to the particular use contemplated. It is intended that the scope of the invention be defined by the claims appended hereto.

We claim:

1. A non-volatile storage device comprising:
a memory die having a plurality of planes including a first plane and a second plane, wherein each of the planes comprises blocks of non-volatile storage elements, wherein the memory die has an interface that is configured to receive commands to access the non-volatile storage elements;
an address translation unit coupled to the plurality of planes, wherein the address translation unit is configured to:
disable one of the first plane or the second plane while selecting the other of the first plane or the second plane based on information stored on the non-volatile storage device that indicates which of the plurality of planes is defective; and
translate block addresses from associated commands that are received on the interface to an appropriate block of the selected one of the first plane or the second plane;
wherein the memory die is configured to access non-volatile storage elements in the selected plane based on the translated block addresses.

2. The non-volatile storage device of claim 1, wherein the commands that are received on the interface are single plane commands.

3. The non-volatile storage device of claim 2, wherein the memory die has a multi-plane mapping having a plane address and a set of bits for a block address, wherein the address translation unit is further configured to:
map the block addresses in the single plane commands to the multi-plane mapping, wherein the block addresses are in a different location in the single plane commands than in the multi-plane mapping.

4. The non-volatile storage device of claim 3, wherein the address translation unit is further configured to:
map block addresses in the disabled plane to block addresses in the selected plane.

5. The non-volatile storage device of claim 4, wherein the address translation is further configured to:
map the block addresses in the selected plane to which the block addresses in the disabled plane were mapped to other block addresses in the selected plane.

6. The non-volatile storage device of claim 1, further comprising:
a memory controller, wherein the non-volatile storage device is configured to inform the memory controller that the memory die is operating as a single plane memory die.

7. The non-volatile storage device of claim 1, wherein the blocks of non-volatile storage elements are arranged as a three-dimensional memory array.

8. The non-volatile storage device of claim 1, wherein the commands that are received on the interface are multi-plane commands, wherein the memory die comprises at least four planes.

9. A method comprising:
receiving a command from a memory controller to access non-volatile storage elements in a memory package, wherein the memory package comprises a memory die having a plurality of planes, wherein the command comprises a block address;
selecting one of the plurality of planes based on information stored in the memory package that indicates which of the plurality of planes is defective;
translating the block address from the command to a memory mapping having a greater number of planes than can be specified in the command; and
accessing the non-volatile storage elements in the selected plane based on the translated block address.

10. A method comprising:
receiving single-plane commands from a memory controller at an interface of a memory device, wherein the memory device comprises a memory die having a first plane and a second plane, wherein the single-plane commands each comprise a block address;
disabling one of the first plane or the second plane, while selecting the other of the first plane or the second plane;
translating block addresses from associated single plane commands that are received on the interface to an appropriate block of the selected one of the first plane or the second plane; and
providing the translated block addresses to an address decoder associated with the selected plane.

11. The method of claim 10, wherein the translating block addresses from associated single plane commands that are received on the interface to an appropriate block of the selected one of the first plane or the second plane comprises:
mapping the block addresses from associated single plane commands to a multi-plane mapping, wherein the block address in a single plane command is in a different location than in the multi-plane mapping.

12. The method of claim 11, wherein the translating block addresses from associated single plane commands that are received on the interface to an appropriate block of the selected one of the first plane or the second plane comprises:
mapping block addresses in the disabled plane to block addresses in the selected plane.

13. The method of claim 12, translating block addresses from associated single plane commands that are received on the interface to an appropriate block of the selected one of the first plane or the second plane further comprises:
mapping the block addresses in the selected plane to which the block addresses in the disabled plane were mapped to other block addresses in the selected plane.

14. The method of claim 11, further comprising:
shifting bits for a Logical Unit Number (LUN) in the single-plane commands, wherein the LUN is in a different location in the single plane commands than in the multi-plane mapping.

15. The method of claim 10, further comprising:
informing a memory controller that the memory die is operating as a single plane device.

16. A non-volatile storage device comprising:
a three-dimensional array of non-volatile storage elements, wherein the three-dimensional array comprises a first plane and a second plane of blocks of the non-volatile storage elements, wherein the three-dimensional array comprises address decoders;
a memory controller;
an interface that is configured to receive commands from the memory controller;
an address translation unit coupled to the three-dimensional array, wherein the address translation unit is configured to:
select the first plane responsive to a determination that the second plane is not operational;
translate an address from a single plane command that is received on the interface to a multi-plane mapping that comprises a plane address, including setting the plane address to the first plane; and
provide the translated address to the address decoders of the three-dimensional array.

17. The non-volatile storage device of claim 16, wherein the address translation unit being configured to select the first plane responsive to a determination that the second plane is not operational comprises the address translation unit to:
access information on the non-volatile storage device that indicates that the second plane is not operational.

18. The non-volatile storage device of claim 16, wherein the address translation unit being configured to translate an address from a single plane command that is received on the interface to a multi-plane mapping that comprises a plane address comprises the address translation unit being configured to:
map block addresses in the second plane to block addresses in the first plane.

19. The non-volatile storage device of claim 16, wherein the address translation unit being configured to translate an address from a single plane command that is received on the interface to a multi-plane mapping that comprises a plane address further comprises the address translation unit being configured to:
map the block addresses in the first plane to which the block addresses in the second plane were mapped to other block addresses in the first plane.

20. The non-volatile storage device of claim 16, further comprising circuitry that is configured to interpret a set of bits in an address of a multi-plane command as a block address, wherein the address translation unit being configured to translate an address from a single plane command that is received on the interface to a multi-plane mapping that comprises a plane address comprises the address translation unit being configured to:
shift bits in the single plane command that correspond to the set of bits in the multi-plane command.
